(19) United States
(12) Patent Application Publication
(10) Pub. No.: US 2025/0021916 A1
(43) Pub. Date: Jan. 16, 2025

(54) REFINING WORKER ENGAGEMENT SURVEYS VIA HUMAN-COMPUTER INTERACTION

(71) Applicant: International Business Machines Corporation, Armonk, NY (US)

(72) Inventors: Soumya Nandy, Bangalore (IN); Mark James Lawrence, Winchester (GB)

(21) Appl. No.: 18/352,089

(22) Filed: Jul. 13, 2023

(51) Int. Cl. G06Q 10/0639; G06Q 10/105

(52) U.S. Cl. CPC G06Q 10/06395; G06Q 10/06393; G06Q 10/105

(57) ABSTRACT

One or more systems, devices, computer program products and/or computer-implemented methods of use provided herein relate to refining employment-based engagement surveys via HCI. The computer-implemented system can comprise a memory that can store computer executable components. The computer-implemented system can further comprise a processor that can execute the computer executable components stored in the memory, wherein the computer executable components can comprise an adjustment component that can adjust one or more answers provided by an individual in an employment-based survey to one or more new respective answers derived from a combination of HCI data of the individual and employment-based data of the individual.

### BACKGROUND

The subject disclosure relates to human-computer interaction (HCI) and, more specifically, to refining worker engagement surveys via HCI.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that can use a combination of HCI data of individuals and employment-based data of the individuals for refining employment-based engagement surveys are discussed.

According to an embodiment, a computer-implemented system is provided. The computer-implemented system can comprise a memory that can store computer-executable components. The computer-implemented system can further comprise a processor that can execute the computer-executable components stored in the memory, where the computer-executable components can comprise an adjustment component that can adjust one or more answers provided by an individual in an employment-based survey to one or more new respective answers derived from a combination of HCI data of the individual and employment-based data of the individual.

According to another embodiment, a computer-implemented method is provided. The computer-implemented method can comprise adjusting, by a system operatively coupled to a processor, one or more answers provided by an individual in an employment-based survey to one or more new respective answers derived from a combination of HCI data of the individual and employment-based data of the individual.

According to yet another embodiment, a computer program product for minimizing human bias in answers provided by an individual in an employment-based questionnaire is provided. The computer program product can comprise a computer readable storage medium having program instructions embodied therewith, the program instructions executable by a processor to cause the processor to adjust, by the processor, one or more answers provided by an individual in an employment-based survey to one or more new respective answers derived from a combination of HCI data of the individual and employment-based data of the individual.

### BRIEF DESCRIPTION OF THE DRAWINGS

FIG. 1 illustrates a block diagram of an example, non-limiting system that can employ a combination of HCI data of an individual and employment-based data of the individual to adjust an answer provided by the individual in an employment-based survey in accordance with one or more embodiments described herein.

FIG. 2 illustrates a flow diagram of an example, non-limiting method that can refine employment-based engagement surveys using a combination of HCI data of individuals and employment-based data of the individuals in accordance with one or more embodiments described herein.

FIG. 3 illustrates another flow diagram of an example, non-limiting method that can refine employment-based engagement surveys using a combination of HCI data of individuals and employment-based data of the individuals in accordance with one or more embodiments described herein.

FIG. 4 illustrates a flow diagram of an example, non-limiting method that can generate recommendations to refine employment-based engagement surveys using a combination of HCI data of individuals and employment-based data of the individuals in accordance with one or more embodiments described herein.

FIG. 5 illustrates a flow diagram of an example, non-limiting method that can be employed to capture HCI data for individuals in an organization in accordance with one or more embodiments described herein.

FIG. 6A illustrates a flow diagram of an example, non-limiting method that can employ a combination of HCI data of individuals and employment-based data of the individuals to neutralize bias associated with an employment-based engagement survey in accordance with one or more embodiments described herein.

FIG. 6B illustrates an example, non-limiting decision tree for a machine learning model (ML model) that can make call-to-action recommendations in accordance with one or more embodiments described herein.

FIG. 7 illustrates a flow diagram of an example, non-limiting method that can enable determination of a final score for an employment-based survey question without adjusting a manual survey score in accordance with one or more embodiments described herein.

FIG. 8 illustrates a flow diagram of an example, non-limiting method that can enable determination of a final score for an employment-based survey question by adjusting a manual survey score in accordance with one or more embodiments described herein.

FIG. 9 illustrates a flow diagram of an example, non-limiting method that can enable determination of a final score for an employment-based survey question based on an outlier in accordance with one or more embodiments described herein.

FIG. 10A illustrates a table based on an example, non-limiting employment-based survey in accordance with one or more embodiments described herein.

FIG. 10B illustrates a continuation of the table from FIG. 10A in accordance with one or more embodiments described herein.

FIG. 10C illustrates a continuation of the table from FIG. 10B in accordance with one or more embodiments described herein.

FIG. 10D illustrates an exemplary graph of effectiveness of an employment-based survey in accordance with one or more embodiments described herein.

FIG. 11 illustrates a flow diagram of an example, non-limiting method that can employ a combination of HCI data of an individual and employment-based data of the individual to adjust an answer provided by the individual in an employment-based survey in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Employment-based engagement surveys (or worker engagement survey) today are questionnaire driven and are often incorrect. True engagement quotients for workers are not always reported due to subjective methods of option selection and scale of the responses. Sometimes the responses provided by the workers are ad hoc and biased and do not represent true responses, resulting in skewed outputs and reports. Any reports built from such survey datasets, are not personalized for individuals and actions are based on segments or groups which do not address specific needs for individual workers.

Embodiments described herein include systems, computer-implemented methods, apparatus and computer program products that can adjust one or more answers provided by an individual in an employment-based survey to one or more new respective answers derived from a combination of human-computer interaction (HCI) data of the individual and employment-based data of the individual acquired from an employer of the individual. Embodiments described herein can combine a range of measurements from HCI data collected over time and employer-held data of an individual to result in a refined engagement survey result to provide an accurate and relevant action-oriented employment-based engagement survey. Various embodiments herein can score surveys based purely on collected HCI data. Embodiments described herein can detect human bias in the one or more answers. Human bias can be described as a negative human factor that can be present in manually collected employment-based engagement survey answers. For example, an individual can provide answers that are not truthful in fear of negative consequences from their employer, or the individual can put no effort when answering questions in a survey and answer all questions in the survey with the highest scores. In another example, expectations of a worker can differ from expectations of their employers, and the individual can answer the questions in the survey too fondly or too harshly for a given scenario.

Embodiments described herein can use HCI and employer-held data of an individual, wherein the HCI and the employer-held data can comprise factual information based on real statistics, to detect human bias in a manual survey answer provided by the individual and adjust the manual survey answer appropriately to a fairer answer. For each survey question, an employer can set the HCI and the employer-held data input sources and parameters. Over time, upon collection of data from individuals employed by the employer, a mode-average of the data for each data source associated with each question can be taken. Each piece of data collected for an individual can be compared to the mode-average for a question and mapped to a Likert scale score, based on deviation of the data values from the mode-average. A mean-average can then be generated for all pieces of data collected for the individual, wherein the mean-average forms a no-touch digital (NTD) score. Thereafter a bias score can be generated using the NTD score and the manually provided score. Thereafter, a fair score can be generated using the bias score and the manually provided score. The fair score can be a more truthful (less biased) answer as compared to the manually provided score.

More specifically, an individual working at an organization can take an employment-based survey and assign manual survey scores in response to questions comprised in the employment-based survey based on a traditional question and answer method. Thereafter, NTD data for a manual survey score assigned by the individual to a question can be captured through HCI data and employer-held data of the individual. NTD data collected for an individual can comprise multiple categories and the NTD data can be scored for individual categories of the multiple categories. Scoring the NTD data of the individual can comprise generating a mode average of NTD data for all individuals employed at the organization for identical categories and mapping the NTD data of the individual to a Likert scale value based on deviation away from the mode average. A mean average of the Likert scale values can generate an NTD score for the question. A bias score can be generated by subtracting the manual survey score from the NTD score. Bias scores for all individuals (e.g., generated based on all individual taking the employment-based survey) can be analyzed to determine bias thresholds or bias score thresholds. If a consistently positive or negative bias score trend can be observed for a question over a period (e.g., a month, a quarter, etc.), then an NTD score for that question can be the final score.

Further, a fair score can be calculated by dividing the bias score by 2, adding the value thus obtained to the manual survey score, and using a nearest whole number of the resultant value as the fair score. A score decider can monitor the bias score and select a final score as an adjusted manual survey score. As indicated earlier, a bias score past the bias score threshold can indicate that a corresponding NTD score is to be used for scoring a question. The score decider can also monitor the bias score trend and adjust the final score, if appropriate. The score decider can use the fair score if a bias score falls within the bias score threshold or the score decider can use the manual survey score for a bias score equal to zero. Based on a combination of the question, the bias score, and the final score, call-to-actions or recommendations can be provided to an employer or manager of the individual. The call-to-actions or recommendations can be administered through machine learning of a standard decision tree model. The model can begin empty but ingest questions and matching bias scores and fair scores. The call-to-actions or recommendations can be initially generated manually by a human entity based on a question sentiment, the bias score and the fair score. In one embodiment, the call-to-actions or recommendations can be initially generated by a hardware, software, machine, or another entity. As more paths in the tree get entered over time, the actions can be recommended automatically by the machine learning. For example, data can be processed through a decision tree model in a software package (e.g., Scikit) that can weight paths through data to make recommendations. In one embodiment, the manager can access the scores and recommendations via the software. In another embodiments, a worker report based on the survey scores and output of the machine learning can be emailed (e.g., by a hardware, software, machine, AI or human entity) to the manager of the individual for actioning, wherein the manager can adjust communications with the worker based on the survey report recommendations.

The machine learning process can have two distinct stages/steps-a learning step and a recommendation step. In an embodiment, the learning step can be a one-time action wherein complete datasets can be loaded into an ML model, and the ML model can be ready to be used for making predictions/recommendations. In one or more embodiments, since sufficient amount of data can initially unavailable, the ML model can be continually re-trained as more data becomes available, and each instance of retraining can improve an ability of the ML model to predict the right call-to-actions. For example, a new survey can be created, and workers within an organization can answer the survey. The HCI data for the workers can also be collected and scored, as described elsewhere herein, to generate various scores (e.g., NTD score, bias scores, and fair scores). Thereafter, the manual survey scores, NTD scores, bias scores, and fair scores can become available and bias thresholds can be decided as described elsewhere herein. Since desired results/outcomes (i.e., call-to-actions) can be undefined at this stage, the scores can be loaded into the ML model at a later stage. At this stage, the software can make the question and the scores available to a manager of a worker, however, due to a lack of recommended call-to-actions to choose from, a user interface (UI) can allow the manager to create a call-to-action. In one embodiment, a system can interface with the UI to receive verbal information from the manager and process the verbal information to create call-to-actions. In another embodiment, the call-to-actions can be created by a hardware, software, machine, AI, or another entity. The manager can then decide one or more actions (i.e., call-to-actions) to be taken in connection with a worker based on the scores. The action can be saved into the system alongside the scores.

Each time a call-to-action can be added or updated in a database (DB), the database comprising questions, scores, and call-to-actions can be formed into a dataset and run through a machine learning decision tree model. Based on learning the information from the dataset, the model can predict known call-to-actions against input scores, additionally providing an accuracy score. Over time, unique call-to-actions can be built up to match against a large combination of scores. Once many call-to-actions can become available in the system, the manager or another manager (e.g., one or more managers can benefit from inputs provided by one or more additional managers) can use the software to assess a worker, wherein scores associated with a worker can be presented, along with a list of call-to-actions in the system and corresponding accuracy scores/values, which can indicate how well the survey scores for the worker match against the scores in the database associated with the call-to-action. For example, an accuracy score of positive 1 (i.e., 1) can indicate an exact match, giving the manager or another entity confidence that a call-to-action is appropriate for use in a scenario. Anything less than 1 (i.e., <1) can indicate that a call-to-action is not an exact match for the survey scores of a worker. The accuracy scores provided by the ML model can indicate to the manager that they need to carefully consider picking an existing call-to-action. The manager can choose to create a new call-to-action in the software against the scores being assessed or the manager can choose an existing call-to-action. In one embodiment, the act of creating the new call-to-action can be performed by a hardware, software, machine, AI, etc. Upon selection of an existing call-to-action, the call-to-action can have a new relationship in the database alongside the different scores, wherein the call-to-action can then represent a one-to-many mapping to a variety of scores, as opposed to only a one-to-one mapping. The process can introduce ranges on attribute value paths to a subsequent node in the ML model. The ML model can be retrained by the software and the process can be continual. Since the survey scores can be captured using software, one or more embodiments herein can be implemented as software. The various scores and relevant information can be easily captured and programmatically placed into datasets to be consumed by a machine learning library.

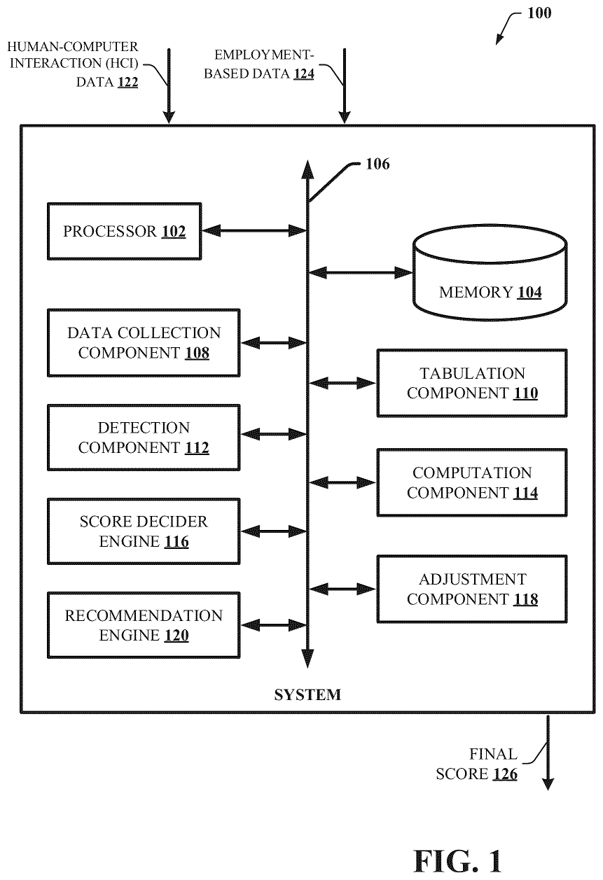

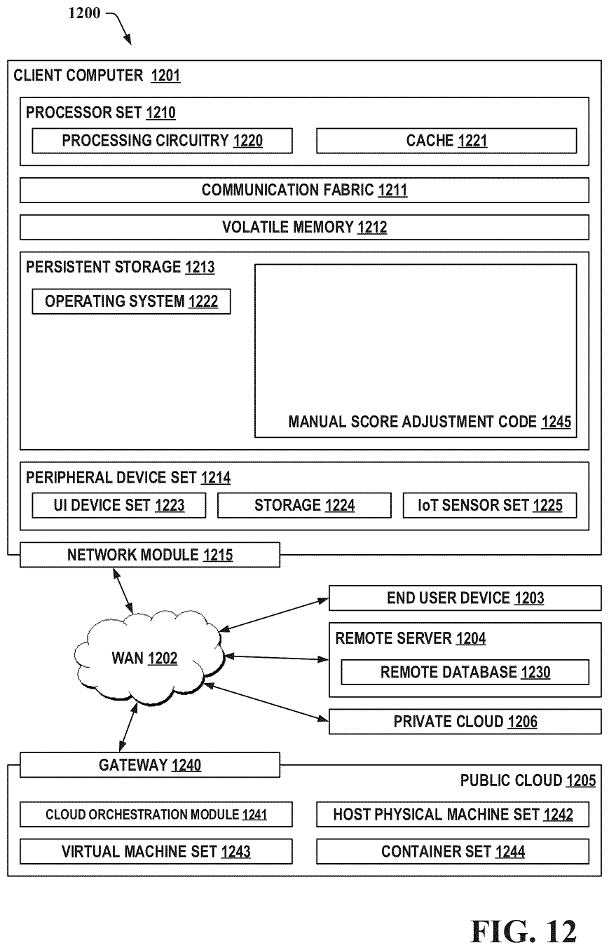

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1200 illustrated at FIG. 12. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can employ a combination of HCI data of an individual and employment-based data of the individual to adjust an answer provided by the individual in an employment-based survey in accordance with one or more embodiments described herein. System 100 can comprise processor 102, memory 104, system bus 106, data collection component 108, tabulation component 110, detection component 112, computation component 114, score decider engine 116, adjustment component 118 and recommendation engine 120.

The system 100 and/or the components of the system 100 can be employed to use hardware and/or software to solve problems that are highly technical in nature (e.g., related to machine learning, collecting HCI data of individuals, refining employment-based engagement surveys via HCI, etc.), that are not abstract and that cannot be performed as a set of mental acts by a human. Further, some of the processes performed can be performed by specialized computers for carrying out defined tasks related to the refining of the employment-based engagement surveys via the HCI. The system 100 and/or components of the system can be employed to solve new problems that arise through advancements in technology, computer networks, the Internet and the like. The system 100 can provide machine learning systems that can generate a list of potential call-to-actions along with an accuracy value. An entity can choose an existing call-to-action, which can cause the call-to-action to have a new relationship in a database, and the call-to-action can be saved against a new combination of score values. The database can be re-run through an ML model, resulting in a change in an attribute value selection on paths to a subsequent node in a decision tree of the ML model. This can further result in a range being used. For example, rather than a selection being based on a fixed bias score (e.g., a bias score=3), the selection can be based on a bias score range (e.g., 3<bias score<5), which can cause a call-to-action to have a better accuracy score, for example, for a bias score of 4.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to processor 102. Memory 104 can store computer-executable instructions that, upon execution by processor 102, can cause processor 102 and/or one or more other components of system 100 (e.g., data collection component 108, tabulation component 110, detection component 112, computation component 114, score decider engine 116, adjustment component 118 and/or recommendation engine 120) to perform one or more actions. In one or more embodiments, memory 104 can store computer-executable components (e.g., data collection component 108, tabulation component 110, detection component 112, computation component 114, score decider engine 116, adjustment component 118 and/or recommendation engine 120).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, adjustment component 118 can adjust one or more answers provided by an individual in an employment-based survey to one or more new respective answers derived from a combination of HCI data of the individual and employment-based data of the individual. Adjusting the answer can comprise generating (e.g., by computation component 114) a first score based on a mean average value of individual scores derived from the combination of the HCI data and the employment-based data of the individual. The first score can be used to generate (e.g., by computation component 114) a second score that can be representative of an amount of human bias in the answer. Score decider engine 116 can use at least the second score to identify an amount of adjustment to be applied to the answer, such that human bias in the answer can be reduced below a defined threshold. Additional aspects of the various embodiments are disclosed hereinafter. System 100 can be associated with, such as accessible via, a computing environment 1200 described below with reference to FIG. 12. For example, system 100 can be associated with a computing environment 1200 such that aspects of processing can be distributed between system 100 and the computing environment 1200.

In an embodiment, adjustment component 118 can adjust one or more answers provided by an individual in an employment-based survey to one or more new respective answers derived from a combination of HCI data (e.g., HCI data 122) of the individual and employment-based data (e.g., employment-based data 124) of the individual. For example, an employment-based survey for an individual can comprise one or more questions related to a professional experience of the individual with an employer, wherein the employment-based survey can be administered by an employer to the individual as a manual survey. Adjustment component 118 can adjust one or more answers provided by the individual to the one or more questions to cause human bias in the one or more answers to be reduced below the defined threshold. The one or more respective answers can be scores (known as manual survey scores) provided in response to the one or more questions (e.g., 3/10, 10/10, etc.) against a Likert scale that can range from values 1-10. For an answer (e.g., for a manual survey score) of the one or more answers, data collection component 108 can collect HCI data and employment-based data of the individual to assist adjustment component 118 to adjust the answer. The HCI data can comprise digital device usage data of the individual, and the employment-based data can be sourced from an employer of the individual. For example, the HCI data can comprise several different categories of data (e.g., eye-tracking data, mouse hesitation data, application usage on worker machines, browsing patterns, health parameters, etc.), and the employment-based data can comprise employer-held data of the individual (e.g., data from human resources (HR) such as sick days, absence, holidays, performance reports, quality and quantity of work, worker retention, etc.). Tabulation component 110 can tabulate the HCI data into respective analysis ratings defined by a worker engagement team associated with an employer of the individual to generate a categorization for the individual for adjusting the one or more answers. Detection component 112 can combine the HCI data and the employment-based data of the individual to detect the human bias in the one or more answers provided by the individual. A combination of HCI data and employment-based data of the individual can form digital data (e.g., no-touch digital (NTD) data) of the individual. Computation component 114 can measure the human bias based on the digital data.

After providing the employment-based survey to the individual, the employment-based survey can be provided to additional individuals employed by the employer. As before, digital data (e.g., a combination of HCI data (e.g., HCI data 122) and employment-based data (e.g., employment-based data 124)) for the additional individuals can be collected (e.g., by data collection component 108) for each question of the employment-based survey. The digital data collected for a question can be in identical categories for the individual and for the additional individuals. The collective digital data (e.g., corresponding to a question on the employment-based survey) for the additional individuals can be used to generate (e.g., by computation component 114) mode average values, wherein a mode average or mode average value for a category of the digital data can be an amount seen the most across an organization. For example, a category of the digital data can be “attendance percentage (%) to project meetings,” and a mode average value for the category can be 100%. Digital data values from identical categories for the individual and the additional individuals can be compared and mapped to a Likert scale to generate individual scores for the digital data of the individual. For example, a value for the category “attendance percentage (%) to project meetings” based on employer-held data for the individual can be 90%, wherein the value can be compared to the mode average value of 100% and mapped to a Likert scale to generate an individual score of “6” on the Likert scale for the individual. For example, a model can be trained by a user to generate individual scores for various situations based on the digital data of the individual and the mode average values. For example, if performance of an individual based on digital data of the individual (e.g., HCI data and employer-held data) can be better that a mode average value for a respective category of the digital data, then the model can generate an individual score of 10 on the Likert scale for the individual for the respective category. In one embodiment, as an initial step for mapping the digital data values to the Likert scale, an administrator of a system, when specifying each HCI data input for a question, can create ranges mapping data values to Likert scores.

In other words, individual scores can be derived from one or more values of the digital data (e.g., for an individual) by mapping the one or more values of the digital data to a Likert scale (e.g., based on deviation away form mode average values of the digital data). Further, adjusting an answer (e.g., by adjustment component 118) provided by the individual to a new answer can comprise generating a first score (e.g., NTD score) based on a mean-average value of the individual scores. The first score can be described as an unbiased score, whereas the manual survey score can have some human bias. Thereafter, the first score can be used to generate a second score (e.g., bias score) that can be representative of an amount of human bias in an answer (e.g., a manual survey score) provided by the individual, wherein the second score can be equal to a difference between the first score and the manual survey score. Score decider engine 116 can use at least the second score to determine an amount of adjustment required for the answer, such that the human bias is reduced below a defined threshold. For example, a third score (e.g., fair score) can be generated (e.g., by computation component 114) by dividing the second score by 2, adding the result to the manual survey score and using a nearest whole number of the value thus generated as the third score. The third score can be representative of the manual survey score adjusted to comprise reduced human bias since the third score can move the manual survey score towards the NTD score (e.g., meeting an individual half-way). Based on the second score, score decider engine 116 can decide whether the manual survey score needs adjustment to a fourth score (e.g., final score 126 or one or more new respective answers), wherein the fourth score can be the manual survey score (e.g., when no adjustment is required), the third score or the first score. For example, a non-zero bias score can indicate that the NTD score and the manual survey score are not equal. Score decider engine 116 can also use bias score thresholds to select the fourth score. For example, for a question in an employment-based survey for an organization, respective bias scores for individuals employed at the organization can be determined and analyzed, and bias score thresholds can be generated for the organization. For example, majority of the individuals can have bias scores between positive 5 (i.e., +5) and negative 5 (i.e., −5) or NTD scores for the individuals can be two points or one point away from corresponding manual survey scores of the individuals. In the first scenario, a bias score threshold for an organization can range from +5 to −5 and an individual bias score of 6 can indicate that a corresponding manual survey score is an outlier due to the bias score falling outside of the bias score threshold.

In an embodiment, the questions in the surveys can be monitored (e.g., by a human entity, a software, etc.) for consistency of the bias scores. For example, for a survey question, if consistently biased scores are reported based on the data collected from an employment-based survey and the NTD score, the survey question can be flagged for a correction/reconfiguration. The bias scores for a survey question can be recorded and the information for each question can be fed to the ML model which can incrementally learn to flag such trends over time. An entire data set (e.g., comprising the question, the manual survey score, the NTD data, the NTD score, the bias score, the fair score, and call-to-actions) for individual questions of the employment-based survey for each worker can be recorded and fed to an ML model. Bias score patterns and all the questions can be monitored and flagged to help tune the survey questions and make the survey more effective.

Recommendation engine 120 can use machine learning (e.g., an ML model) to recommend one or more actions, based on an amount of adjustment to one or more answers provided by the individual in the employment-based survey, that the employer of the individual can execute to maintain performance of the individual above a performance threshold. Training data used to train the machine learning to recommend the one or more actions can comprise information based on a human entity analyzing bias thresholds for the one or more answers to determine outliers. For example, the human entity can analyze the bias thresholds to enable identification of outliers in the employment-based survey using the HCI data and the employment-based data of the individual, and data generated from such analysis over time can comprise training data used to train the machine learning, additional aspects of which are disclosed with reference to subsequent figures. In one embodiment, the bias thresholds for the one or more answers can be analyzed by a hardware, software, machine, or another entity. Training the machine learning to recommend the one or more actions can comprise structuring manual survey scores, calculated scores (e.g., NTD score, bias score, etc.) and recommendations into structured data sets, wherein the structured data sets can be loaded into a decision tree modeller software package that can create tree paths and weights through the data.

Thus, for a specific question on the employment-based survey, there can be multiple parameters (e.g., various categories of digital data) such that the question can be extrapolated using the multiple parameters. Such extrapolation can generate true (e.g., unbiased) objective data from worker-employer interactions comprised within an information database of an organization, instead of relying only on binary responses (e.g., yes/no) from an individual taking the employment-based survey. Once manual survey scores are acquired from the individual, the information can be interpreted at two levels. At a first level, HCI data and employer statistics for all individuals in an organization in particular segments/categories (e.g., mode average) can be collected, and at a second level, HCI data and employer statistics for a specific individual with respect to factual data for attribute parameters based on the question can be collected. Thereafter, respective NTD scores for respective questions can be identified, wherein an NTD score can be an unbiased response to a question and a true representation of a situation, as opposed to a manual survey score provided by the individual. Thus, an NTD score being significantly different from a manual survey score can indicate that a corresponding manual survey score is not the true representation of the situation.

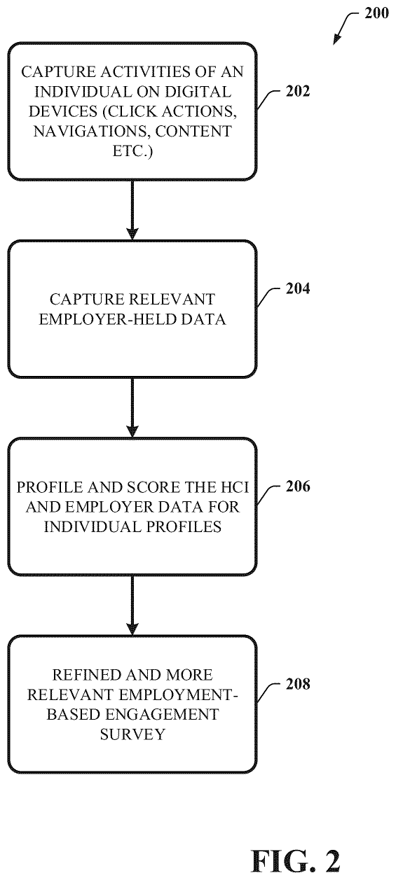

FIG. 2 illustrates a flow diagram of an example, non-limiting method 200 that can refine employment-based engagement surveys using a combination of HCI data of individuals and employment-based data of the individuals in accordance with one or more embodiments described herein. Repetitive description of like elements and/or processes employed in respective embodiments is omitted for sake of brevity.

FIG. 2 illustrates a high-level process for refining employment-based engagement surveys. At 202 of the non-limiting method 200, HCI data of an individual can be captured in connection with an employment-based engagement survey in an organization employing the individual (e.g., activities of the individual on digital devices (click actions, navigations, content etc.)). At 204 of the non-limiting method 200, relevant employer-held data of the individual can be captured. At 206 of the non-limiting method 200, the HCI data and the employer-held data for the individual can be profiled and scored against HCI data and employer-held data for all individuals employed in the organization. At 208 of the non-limiting method 200, refined and more relevant employment-based engagement surveys can be generated.

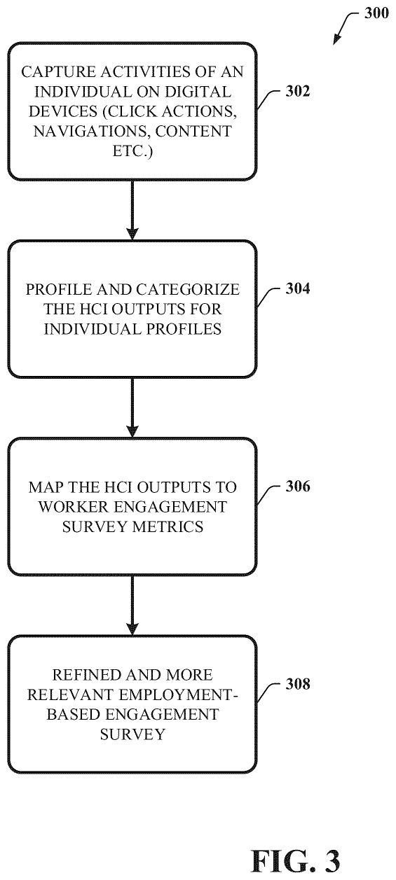

FIG. 3 illustrates another flow diagram of an example, non-limiting method 300 that can refine employment-based engagement surveys using a combination of HCI data of individuals and employment-based data of the individuals in accordance with one or more embodiments described herein. Repetitive description of like elements and/or processes employed in respective embodiments is omitted for sake of brevity.

FIG. 3 illustrates a high-level process for refining employment-based engagement surveys, and the non-limiting method 300 is analogous to the non-limiting method 200. Detailed aspects of the non-limiting methods 200 and 300 are described at least with reference to one or more subsequent figures. At 302 of the non-limiting method 300, HCI data of an individual can be captured in connection with an employment-based engagement survey in an organization employing the individual (e.g., activities of the individual on digital devices (click actions, navigations, content etc.)). At 304 of the non-limiting method 300, the HCI outputs can be profiled and categorized for individual profiles. At 306 of the non-limiting method 300, the HCI outputs can be mapped to worker engagement survey metrics. At 308 of the non-limiting method 300, refined and more relevant employment-based engagement surveys can be generated.

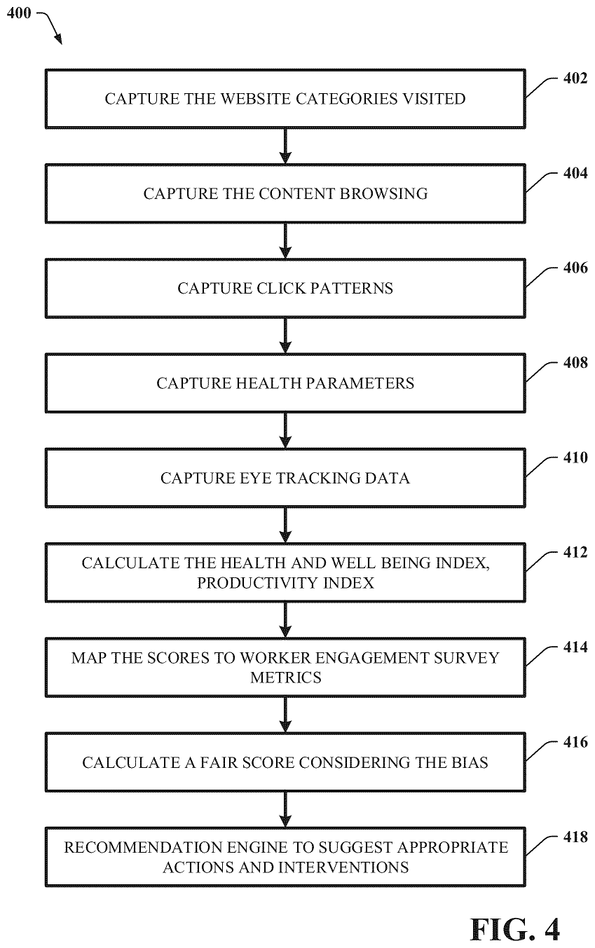

FIG. 4 illustrates a flow diagram of an example, non-limiting method 400 that can generate recommendations to refine employment-based engagement surveys using a combination of HCI data of individuals and employment-based data of the individuals in accordance with one or more embodiments described herein. Repetitive description of like elements and/or processes employed in respective embodiments is omitted for sake of brevity.

As described elsewhere herein, an employment-based survey for an individual can comprise one or more questions related to a professional experience of the individual with an employer, wherein the employment-based survey can be administered by the employer to the individual as a manual survey. Adjustment component 118 (FIG. 1) can adjust one or more answers respectively provided by the individual for the one or more questions such that human bias in the one or more answers can be reduced below the defined threshold. The one or more respective answers can be scores (known as manual survey scores) provided in response to the one or more questions (e.g., 3/10, 10/10, etc.) against a Likert scale that can range from values 1-10.

For each answer (e.g., for each manual survey score) of the one or more answers, non-limiting method 400 can enable collecting HCI data 122 (FIG. 1) and employment-based data 124 (FIG. 1) of the individual to assist adjustment component 118 to adjust the answer, wherein HCI data 122 can comprise digital device usage data of the individual, and employment-based data 124 can be sourced from an employer of the individual. For example, at 402 of non-limiting method 400, data collection component 108 can capture website categories visited by the individual. At 404 of non-limiting method 400, data collection component 108 can capture content browsed by the individual. At 406 of non-limiting method 400, data collection component 108 can capture click patterns of the individual. At 408 of non-limiting method 400, data collection component 108 can capture health parameters of the individual. At 410 of non-limiting method 400, data collection component 108 can capture eye tracking data of the individual. At 412 of non-limiting method 400, computation component 114 can calculate a health and well being index and productivity index of the individual based on data collected by data collection component 108. At 414 of non-limiting method 400, scores generated based on HCI data 122 and employment-based data 124 of the individual can be mapped to worker engagement survey metrics to generate an NTD score corresponding to the answer.

A difference of the NTD score and the manual survey score can result in a bias score indicative of bias present in the answer provided by the individual. As such, respective NTD scores can be generated for various manual survey scores provided by the individual in response to the one or more questions. At 416 of non-limiting method 400, computation component 114 can calculate a fair score based on the bias. Score decider engine 116 can decide to adjust the manual survey score to final score 126, wherein final score 126 can be the manual survey score when the bias score is zero, and wherein final score 126 can be the NTD score or the fair score, when the bias score is not zero or when a bias score trend indicates that the NTD score can be used as final score 126. At 418 of non-limiting method 400, recommendation engine 120 (FIG. 1) can use machine learning (e.g., an ML model) to suggest appropriate actions and interventions, based on final score 126, that the employer of the individual can execute to maintain performance of the individual above a performance threshold.

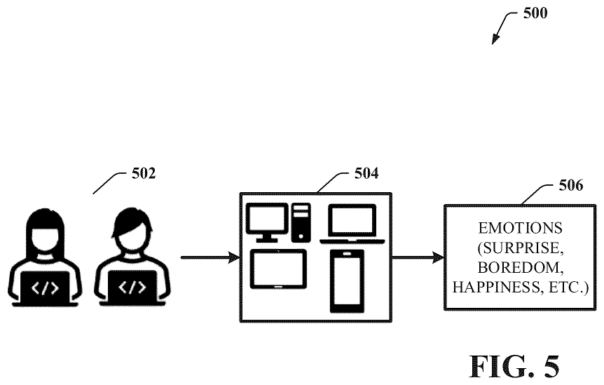

FIG. 5 illustrates a flow diagram of an example, non-limiting method 500 that can be employed to capture HCI data for individuals in an organization in accordance with one or more embodiments described herein. Repetitive description of like elements and/or processes employed in respective embodiments is omitted for sake of brevity.

Various embodiments described herein can assist in determining whether user engagement can be captured more non-intuitively and accurately in a completely digital world where most users can be digital natives. The information can be used to resolve an HR-related problem, to generate a relevant engagement survey which can be actioned appropriately for individuals in an organization. For example, non-limiting method 500 can be used to promote better worker engagement while workers work long hours on digital devices, track customer emotions while customers visit ecommerce sites or web pages and interact with displayed digital assets, etc.

At 502 and 504 of non-limiting method 500, data collection component 108 can capture information from HCI of individuals/customers during working hours of the individuals/customers, wherein the information can be used by a system (e.g., system 100) to understand emotions of the individuals/the customers while they work on computers/laptops/other digital devices, etc. (e.g., different work modes) away from physical human interaction.

At 506 of non-limiting method 500, an artificial intelligence (AI) model/AI models can be employed to analyze mouse click patterns, interpret focus/stare of the users on web/content pages (eye tracking), sites visited, etc., browsing patterns, delays in actions/clicks, etc. to analyze sentiments and emotions (e.g., surprise, boredom, happiness, sadness, etc.) of the users. For example, the AI model/AI models can perform real-time detection of mouse click patterns, real-time detection of eye movements, etc. HCI outputs thus generated can be used to generate an engagement quotient since engagement and experience quotients can be based on key business metrics. The HCI outputs combined with engagement survey metrics can be used to generate relevant and actionable scores, in accordance with embodiments discussed herein.

Various types of data can be collected during a survey. Any suitable techniques known in the art for data capture can be employed in connection with the subject innovation. For example, a data capture methodology based on mouse movement data can comprise tracking a mouse pointer or mouse cursor to capture a trajectory of mouse movement and various mouse movement patterns can be captured. For example, mouse scrolling patterns over a survey, patterns indicating fast versus slow decision making, patterns of revisiting questions, hovering or pausing patterns, straight and curvy cursor patterns, mouse direction inversion patterns, random patterns, loop patterns, etc. can be captured. Tracking of eye movements based on one or more similar patterns can also be implemented. The patterns can be analyzed to extract personality traits or sentiments of individuals. Any positive of negative information found can affect an NTD score. For example, random patterns of mouse movement can be demonstrated by an individual, which can indicate no specific intention and can lead to invalid results.

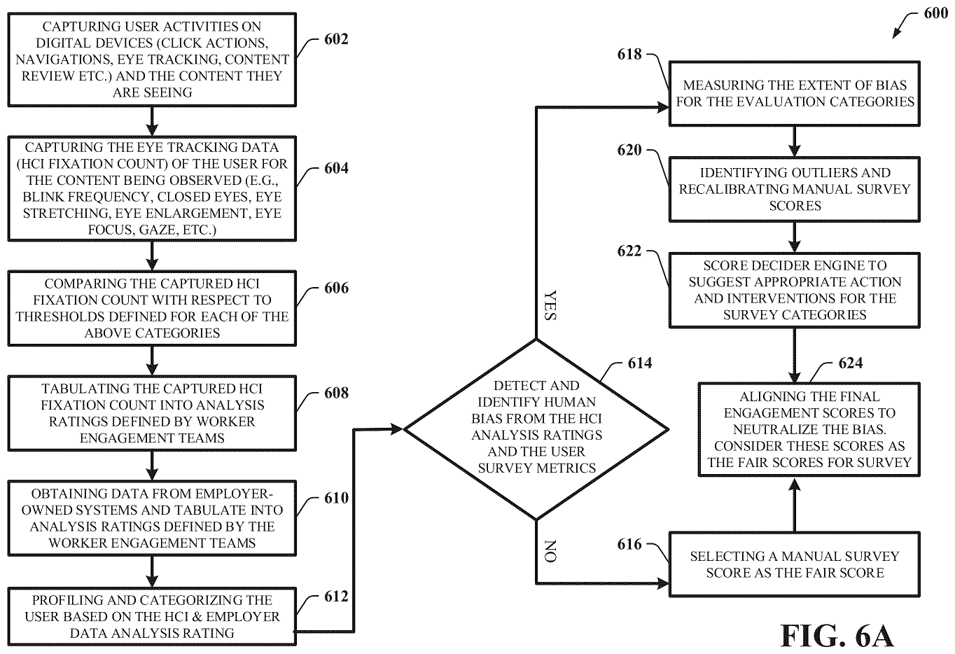

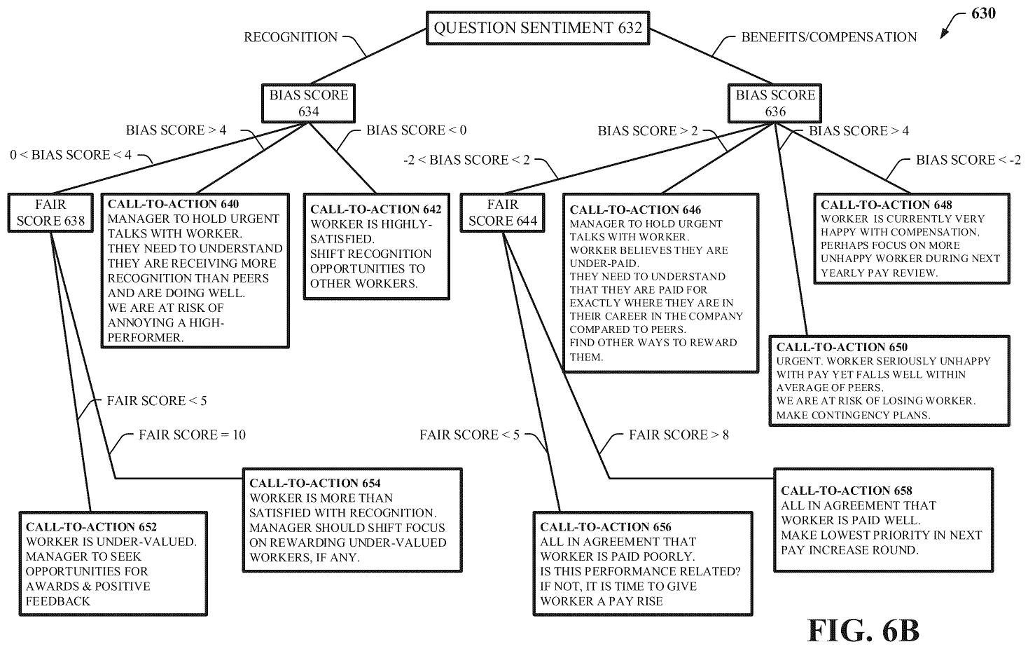

FIG. 6A illustrates a flow diagram of an example, non-limiting method 600 that can employ a combination of HCI data of individuals and employment-based data of the individuals to neutralize bias associated with an employment-based engagement survey in accordance with one or more embodiments described herein. Repetitive description of like elements and/or processes employed in respective embodiments is omitted for sake of brevity.

At 602, the non-limiting method 600 can comprise capturing (e.g., by data collection component 108) user activities on digital devices (click actions, navigations, eye tracking, content review, etc.) and content being viewed by the user. At 604, the non-limiting method 600 can comprise capturing (e.g., by data collection component 108) eye tracking data (e.g., HCI fixation count) of the user for the content being observed. The eye tracking data can comprise blink frequency, closed eyes, eye stretching, eye enlargement, eye focus, gaze, etc. At 606, the non-limiting method 600 can comprise comparing (e.g., by detection component 112 or computation component 114) the captured HCI fixation count with respect to thresholds defined for the above categories. At 608, the non-limiting method 600 can comprise tabulating (e.g., by tabulation component 110) the captured HCI fixation count into analysis ratings defined by worker engagement teams. At 610, the non-limiting method 600 can comprise obtaining (e.g., by data collection component 108) data from employer-owned systems and tabulating (e.g., by tabulation component 110) the data into analysis ratings defined by the worker engagement teams. At 612, the non-limiting method 600 can comprise profiling and categorizing the user based on the HCI fixation count and employer data analysis ratings.

Further, at 614, the non-limiting method 600 can comprise detecting and identifying (e.g., by detection component 112) human bias from the HCI fixation count analysis ratings and user survey metrics. If no bias is detected, the non-limiting method 600 can comprise, at 616, selecting a manual survey score (e.g., score decider engine 116) as a fair score (e.g., score decider engine 116). If bias is detected, the non-limiting method 600 can comprise, at 618, measuring (e.g., by computation component 114) an extent of the bias for various evaluation categories. For example, computation component 114 can measure the bias based on a mean baseline score, wherein a positive value and a negative value of the mean baseline score can determine the bias thresholds. At 620, the non-limiting method 600 can comprise identifying outliers and recalibrating the manual survey score. For example, a higher bias can indicate higher deviation, and higher deviation can indicate a probability that an assessment category is an outlier. At 622, the non-limiting method 600 can comprise suggesting (e.g., by score decider engine 116) appropriate actions and interventions for the survey categories. At 624, the non-limiting method 600 can comprise aligning (e.g., by adjustment component 118) the final engagement scores to neutralize the bias. The final engagement scores can be considered the fair score for the survey.

FIG. 6B illustrates an example, non-limiting decision tree 630 for an ML model that can make call-to-action recommendations in accordance with one or more embodiments described herein. Repetitive description of like elements and/or processes employed in respective embodiments is omitted for sake of brevity.

As stated elsewhere herein. recommendation engine 120 (FIG. 1) can use machine learning (e.g., an ML model) to recommend one or more actions (e.g., call-to-actions), based on an amount of adjustment to one or more answers provided by an individual in an employment-based survey, that an employer of the individual can execute to maintain performance of the individual above a performance threshold. The decision tree can be continually trained each time that new scores and call-to-actions become added into the system. With each iteration of training, a prediction model can improve. A machine learning algorithm employed by the ML model for recommending the call-to-actions can be based on the trained decision tree, wherein the trained decision tree can rely upon a question category, a question, scores, deviations from the scores, etc. to come up with a call-to-action. For example, a top node of the decision tree can be “category” (e.g., a question category), followed by a value of the category that can lead the machine learning algorithm down a particular path to the next node. The ML model can learn from different call-to-actions for the decision tree and make recommendations for similar type of questions. The machine learning algorithm can recommend different call-to-actions based on the category and different bias scores and/or fair scores. In other words, the category, the bias score and the fair score can be deciding factors that can cause the machine learning algorithm to walk a particular path down through a decision tree. For example, the machine learning algorithm can start at the top node of “category”, wherein there can be several possible categories, and wherein one question can only have one category. From the top node, the machine learning algorithm can decide on a path which can be taken to the next node, wherein the next node can be a bias score. Depending on a value of the bias score, a range of paths can be taken to a next potential node, but only one node can be selected.

In one or more embodiments, the ML model can capture data and learn to recommend call-to-actions in a supervised fashion. In one or more other embodiments, the ML model can flag the questions in the survey for tuning/reconfiguration from the data captured in the process. Scores can be collected by a digital piece of software, and the scores can be immediately, without manual intervention, mapped into datasets. That is, the scores can immediately be input into the machine learning algorithm. The datasets can be input to a software (e.g., such as Scikit which is written in Python), and the software can traverse through data comprised in the datasets to work out the paths and weight them, such that upon receiving new scores at a subsequent time, the software can walk down the paths created by the machine learning algorithm. In other words, after acquiring the scores and supplying the scores to the software, the software can ask an entity (e.g., a manager at a UI, hardware, software, AI or another entity) to select a recommendation. Upon witnessing new scores at a later point in time, wherein the new scores can be about the same as the scores previously supplied to the software, the software can suggest an auto-recommendation that can be the recommendation input by the manager into the system. Thus, the ML model can learn how to traverse a path that has been traversed in a previous scenario. The ML model also has the capability to identify a nearest call-to-action (e.g., closest match based on a particular score) and recommend the call-to-action to a manager, a decision maker, or another entity. The entity can intervene or update a response which can be input into the ML model, wherein the ML model can create another scenario to leverage.

In a non-limiting example, as illustrated in FIG. 6B, a top node of decision tree 630 can be question sentiment 632. Wherein question sentiment 632 can be related to recognition at the workplace (i.e., value of the top node), the value of the top node can lead the machine learning algorithm to bias score 634. Based on bias thresholds for the scenario, if the bias score falls between 0 and 4, the machine learning algorithm can make the decision to recommend call-to-actions based on a fair score. The machine learning algorithm can further analyze the fair score to decide on the specific call-to-actions that can be recommended. Based on bias thresholds for the scenario, if the bias score does not fall between 0 and 4, the machine learning can make the decision to recommend call-to-actions based on the bias score. For example, for a bias score between 0 and 4, the machine learning algorithm can recommend call-to-actions based on fair score 638, as discussed in one or more embodiments herein. For a fair score less than 5, the machine learning algorithm can recommend call-to-action 652 to a manager, suggesting that a worker is under-valued, and the manager of the worker is to seek opportunities for awards and positive feedback. For a fair score equal to 10, the machine learning algorithm can recommend call-to-action 654 to a manager, suggesting that a worker is more than satisfied with recognition and the manager should shift focus on rewarding under-valued workers, if any. For a bias score greater than 4, the machine learning algorithm can recommend call-to-action 640 to a manager, suggesting that the manager is to hold urgent talks with the worker since the worker needs to understand that they are receiving more recognition than peers and are doing well. Call-to-action 640 can indicate to an employer/manager that the employer/manager can be at risk of annoying a high-performer. Likewise, for a bias score less than zero, the machine learning algorithm can recommend call-to-action 642 to a manager, suggesting that the worker is highly satisfied and the manager is to shift recognition opportunities to other workers.

In another non-limiting example, as illustrated in FIG. 6B, a top node of decision tree 630 can be question sentiment 632. Wherein question sentiment 632 can be related to benefits/compensation (i.e., value of the top node), the value of the top node can lead the machine learning algorithm to bias score 636. Based on bias thresholds for the scenario, if the bias score falls between negative 2 (i.e., −2) and positive 2 (i.e., 2), the machine learning algorithm can make the decision to recommend call-to-actions based on a fair score. The machine learning algorithm can further analyze the fair score to make a decision on the specific call-to-actions that can be recommended. Based on bias thresholds for the scenario, if the bias score does not fall between −2and 2, the machine learning can make the decision to recommend call-to-actions based on the bias score. For example, for a bias score between −2 and 2, the machine learning algorithm can recommend call-to-actions based on fair score 644, as discussed in one or more embodiments herein. For a fair score less than 5, the machine learning algorithm can recommend call-to-action 656 to a manager, suggesting that all parties agree that a worker is paid poorly. Call-to-action 656 can indicate that the manager is to analyze if the poor pay is performance related and if not, give a pay rise to the worker. For a fair score greater than 8, the machine learning algorithm can recommend call-to-action 658 to a manager, suggesting that all parties agree that the worker is paid well and the manager is to make the worker's pay the lowest priority during a subsequent pay increase cycle. For a bias score greater than 2, the machine learning algorithm can recommend call-to-action 646 to a manager, suggesting that the manager is to hold urgent talks with the worker since the worker can have a belief that they are under-paid and the worker needs to understand that they are paid according to their position in their career at the company in comparison to their peers. Call-to-action 646 can indicate to an employer/manager that the employer/manager can identify other ways to reward the worker. For a bias score less than −2, the machine learning algorithm can recommend call-to-action 648 to a manager, suggesting that the worker is currently happy with compensation and the manager can focus on more unhappy workers during a subsequent yearly pay review. For a bias score greater than 4, the machine learning algorithm can recommend call-to-action 650 to a manager, indicating an urgent situation wherein a worker is seriously unhappy with pay yet falls well within an average of peers. Call-to-action 650 can indicate to an employer/manager that the employer/manager can be at risk of losing the worker and is to make contingency plans.

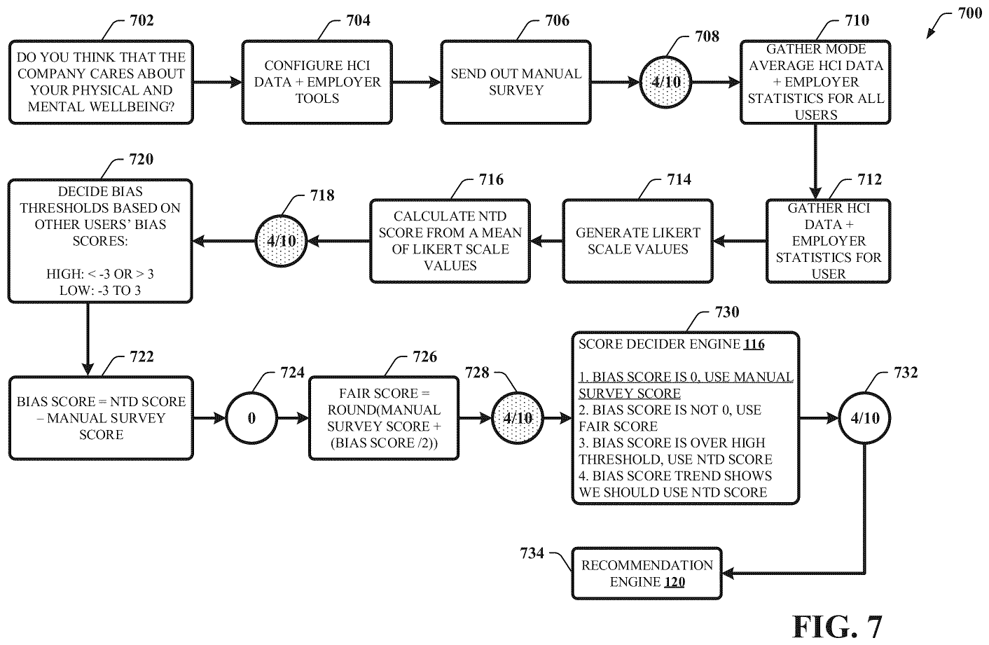

FIG. 7 illustrates a flow diagram of an example, non-limiting method 700 that can enable determination of a final score for an employment-based survey question without adjusting a manual survey score in accordance with one or more embodiments described herein. Repetitive description of like elements and/or processes employed in respective embodiments is omitted for sake of brevity. One or more steps of non-limiting method 700 can be performed by one or more components of system 100.

In a non-limiting example, an employment-based survey generated by an employer or organization for individuals employed by the employer or organization can comprise one or more questions. For example, an employment-based survey question (e.g., question 702) can be “Do you think that the company cares about your physical and mental wellbeing?” At 704, HCI data and employer-based data (employer tools) can be configured, wherein the HCI data and the employer-based data (collectively, digital data or NTD data) can comprise categories relevant to the question. For example, eight categories of the digital data can be configured for question 702, as listed in table 1. A category of employer-based data can be “manager logged incidents of character,” whereas a category of HCI data can be “eye tracking on self-help websites” (e.g., how many times did eyes fixate at phrases/words associated at wellness/fitness (stress, anxiety, job satisfaction).

TABLE 1
Digital data categories for question 702

| | | | | Likert |
|---|---|---|---|---|
| | | | | scale |
| # | Categories | Mode-average | Digital data | values |
| 1 | Attendance to wellness sessions | 5 sessions (average) | 2/8 sessions (worse) | 3 |
| 2 | Number of hours at workplace | 70 hours (average) | 84 hours (better) | 8 |
| | gym | | | |
| 3 | Manager logged incidents of | 0 (exceptional) | 1 (bad) | 3 |
| | character | | | |
| 4 | Average daily calories consumed | 100 (average) | 322 (worse) | 4 |
| | in restaurant by junk food | | | |
| 5 | Sick days | 1 (average) | 2 (worse) | 4 |
| 6 | Reports of poor performance | 0 (exceptional) | 1 (bad) | 3 |
| 7 | Number of accidents reported | 0 (exceptional) | 1 (bad) | 4 |
| 8 | Eye tracking on self-help websites | 20 (average) | 92 (bad) | 3 |

At 706, a manual survey comprising question 702 can be sent to an individual within the organization and at 708, the individual can respond to question 702 with a manual survey score of 4/10. As stated elsewhere herein, the manual survey score can be generated against a Likert scale that can range from values 1-10. At 710, HCI data and employment-based (e.g., employer statistics) for all individuals can be collected for the categories listed in table 1 and a mode average value for each category can be generated as listed under the column heading “mode average” in table 1. The mode average value for a category of the digital data can be an amount seen the most across the organization for the category. At 712, digital data for the individual can be collected for the categories listed in table 1. The values for the digital data of the individual are listed under the column heading “digital data” in table 1.

At 714, Likert scale values for the digital data of the individual corresponding to question 702 can be generated by comparing the digital data values with the mode average values for respective categories. For example, for the category “attendance to wellness sessions,” a score of 5 can be considered average and a score of 2 can be considered worse, resulting in a Likert scale value of 3. The various designations (e.g., average, worse, exceptional, etc.) for the mode average values and the digital data values can be as listed in table 1 alongside the corresponding Likert scale values. At 716, computation component 114 can calculate a mean value of the Likert scale values to generate an NTD score for question 702 at 718. For example, the NTD score for question 702 can be 4/10 according to equation 1.

$$NTD score for question 702 = ( 3 + 8 + 3 + 4 + 4 + 3 + 4 + 3 ) / 8 = 4 \qquad Equation 1$$

At 720, bias thresholds can be decided for question 702 based on respective bias scores for individuals employed across the organization, wherein a bias score for an individual can be generated by subtracting a manual survey score from the NTD score. For example, bias thresholds for question 702 can comprise a high value of less than negative 3 (i.e., <−3) or greater than positive 3 (i.e., >3) and a low value between −3 and 3, wherein the bias thresholds can indicate that majority of the individuals can have bias scores between the ranges indicated herein. At 722, computation component 114 can subtract the manual survey score of the individual from the NTD score of the individual to generate a bias score for the individual at 724. For question 702, the bias score of the individual can be zero, which can indicate that the manual survey score provided by the individual has zero bias. At 726, computation component 114 can divide the bias score by 2, add the value thus obtained to the manual survey score, and compute a nearest whole number of the resultant value (e.g., resulting from adding the manual survey score to half of the bias score) to generate a fair score at 728. For question 702, the fair score of the individual can be 4/10.

At 730, score decider engine 116 can use the bias score to determine a final score at 732. For example, the bias score being zero for question 702 can indicate that the individual answered the question honestly and the bias score cannot be affected later by the bias score trend. Thus, score decider engine 116 can select the manual survey score as the final score, as indicated via the underlined at 730. At 734, recommendation engine 120 can use machine learning (e.g., an ML model) to suggest appropriate actions and interventions, based on the final score, that the employer of the individual can execute to maintain performance of the individual above a performance threshold. For example, recommendation engine 120 can recommend that the employer or a manager can have discussions with the individual to improve the final score, the employer can promote the workplace gymnasium more, the manager can check if wellness sessions are conducted at times suitable to the individual, etc. to improve the final score.

The machine learning can be trained over time to make the recommendations based on the final score. For example, a human entity can make initial recommendations based on the bias score and the final score to determine call-to-actions. For example, the human entity can analyze the bias score of zero and recommend call-to-actions for the question. In an embodiment, a hardware, software, machine, AI, etc. can make the initial recommendations. Over time, such historical recommendations can be used to generate training data to train the machine learning to make the recommendations based on answers provided by the individual.

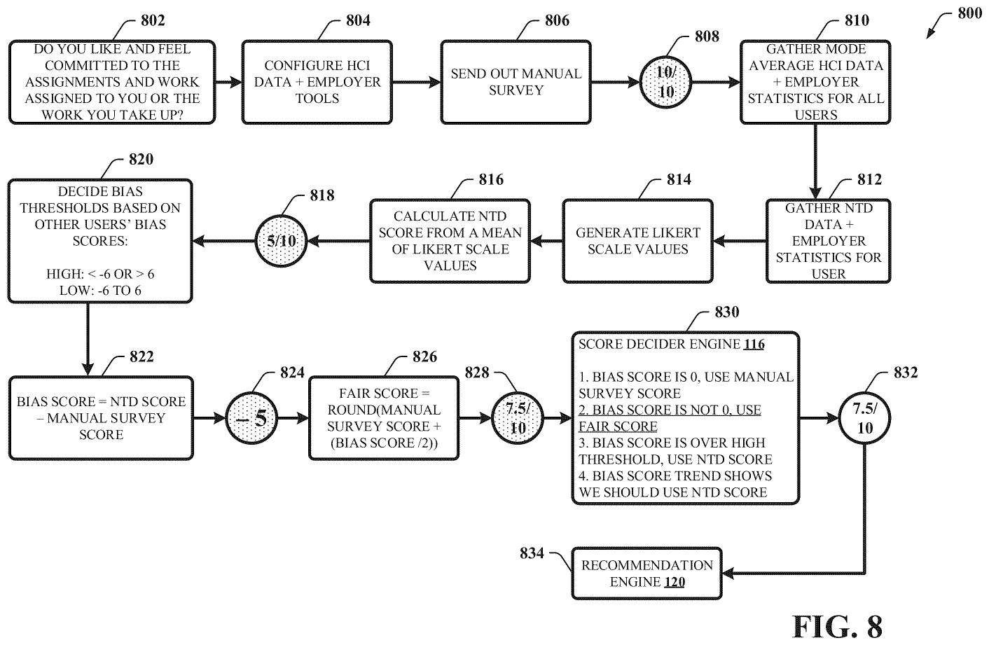

FIG. 8 illustrates a flow diagram of an example, non-limiting method 800 that can enable determination of a final score for an employment-based survey question by adjusting a manual survey score in accordance with one or more embodiments described herein. Repetitive description of like elements and/or processes employed in respective embodiments is omitted for sake of brevity. One or more steps of non-limiting method 800 can be performed by one or more components of system 100.

In a non-limiting example, an employment-based survey generated by an employer or organization for individuals employed by the employer or organization can comprise one or more questions. For example, an employment-based survey question (e.g., question 802) can be “Do you like and feel committed to the assignments and work assigned to you or the work you take up?” At 804, HCI data and employer-based data (employer tools) can be configured, wherein the HCI data and the employer-based data (collectively, digital data or NTD data) can comprise categories relevant to the question. For example, six categories of the digital data can be configured for question 802, as listed in table 2. A category of employer-based data can be “attendance percentage (%) to project meetings,” whereas a category of HCI data can be “eye tracking on job seeking websites” (e.g., how many times did eyes fixate at phrases/words associated with changing jobs.

TABLE 2
Digital data categories for question 802

| | | | | Likert |
|---|---|---|---|---|
| | | | | scale |
| # | Categories | Mode-average | Digital data | values |
| 1 | Attendance % to project | 100 | 90 (worse) | 6 |
| | meetings | (exceptional) | | |
| 2 | Number of work items done | 2 (average) | 2 (same) | 5 |
| | overestimate | | | |
| 3 | Number of positive | 1 (average) | 1 (same) | 5 |
| | feedbacks individual has | | | |
| | given to team lead | | | |
| 4 | Reports of poor | 0 (exceptional) | 1 (worse) | 5 |
| | performance | | | |
| 5 | Eye tracking on job | 70 (average) | 70 (same) | 5 |
| | seeking websites | | | |
| 6 | Hours on non-work | 5 (average) | 7 (worse) | 4 |
| | related websites | | | |

At 806, a manual survey comprising question 802 can be sent to an individual within the organization and at 808, the individual can respond to question 802 with a manual survey score of 10/10. As stated elsewhere herein, the manual survey score can be generated against a Likert scale that can range from values 1-10. At 810, HCI data and employment-based (e.g., employer statistics) for all individuals can be collected for the categories listed in table 2 and a mode average value for each category can be generated as listed under the column heading “mode average” in table 2. The mode average value for a category of the digital data can be an amount seen the most across the organization for the category. At 812, digital data for the individual can be collected for the categories listed in table 2. The values for the digital data of the individual are listed under the column heading “digital data” in table 2.

At 814, Likert scale values for the digital data of the individual corresponding to question 802 can be generated by comparing the digital data values with the mode average values for respective categories. For example, for the category “number of positive feedbacks individual has given to team lead,” a score of 1 can be considered average, resulting in a Likert scale value of 5. The various designations (e.g., average, worse, exceptional, etc.) for the mode average values and the digital data values can be as listed in table 2 alongside the corresponding Likert scale values. At 816, computation component 114 can calculate a mean value of the Likert scale values to generate an NTD score for question 802 at 818. For example, the NTD score for question 802 can be 5/10 according to equation 2.

$$NTD score for question 802 = ( 6 + 5 + 5 + 5 + 5 + 4 ) / 6 = 5 \qquad Equation 2$$

At 820, bias thresholds can be decided for question 802 based on respective bias scores for individuals employed across the organization, wherein a bias score for an individual can be generated by subtracting a manual survey score from the NTD score. For example, bias thresholds for question 802 can comprise a high value of less than negative 6 (i.e., <−6) or greater than 6 (>6) and a low value between −6 and 6, wherein the bias thresholds can indicate that majority of the individuals can have bias scores between the ranges indicated herein. At 822, computation component 114 can subtract the manual survey score of the individual from the NTD score of the individual to generate a bias score for the individual at 824. For question 802, the bias score of the individual can be negative (i.e., −5), which can indicate that the manual survey score provided by the individual has bias. At 826, computation component 114 can divide the bias score by 2, add the value thus obtained to the manual survey score, and compute a nearest whole number of the resultant value (e.g., resulting from adding the manual survey score to half of the bias score) to generate a fair score at 828. For question 802, the fair score of the individual can be 7.5/10.

At 830, score decider engine 116 can use the bias score to determine a final score at 832. For example, the bias score being −5 for question 802 can indicate that the individual answered the question with negative bias. Thus, score decider engine 116 can select the fair score as the final score, as indicated via the underlined at 830. Adjustment component 118 can adjust the manual survey score to the fair score. At 834, recommendation engine 120 can use machine learning (e.g., an ML model) to suggest appropriate actions and interventions, based on the final score, that the employer of the individual can execute to maintain performance of the individual above a performance threshold. For example, recommendation engine 120 can recommend that the employer or a manager can have discussions with the individual to set expectations or that the individual can attempt to understand that the individual is meeting expectations, since the individual scored themselves too high (e.g., manual survey score).

The machine learning can be trained over time to make the recommendations based on the final score. For example, a human entity can make initial recommendations based on the bias score and the final score to determine call-to-actions. For example, the human entity can analyze the bias score of −5 and recommend call-to-actions for the question. In one embodiment, a hardware, software, machine, AI, etc. can make the initial recommendations. Over time, such historical recommendations can be used to generate training data to train the machine learning to make the recommendations based on answers provided by the individual.

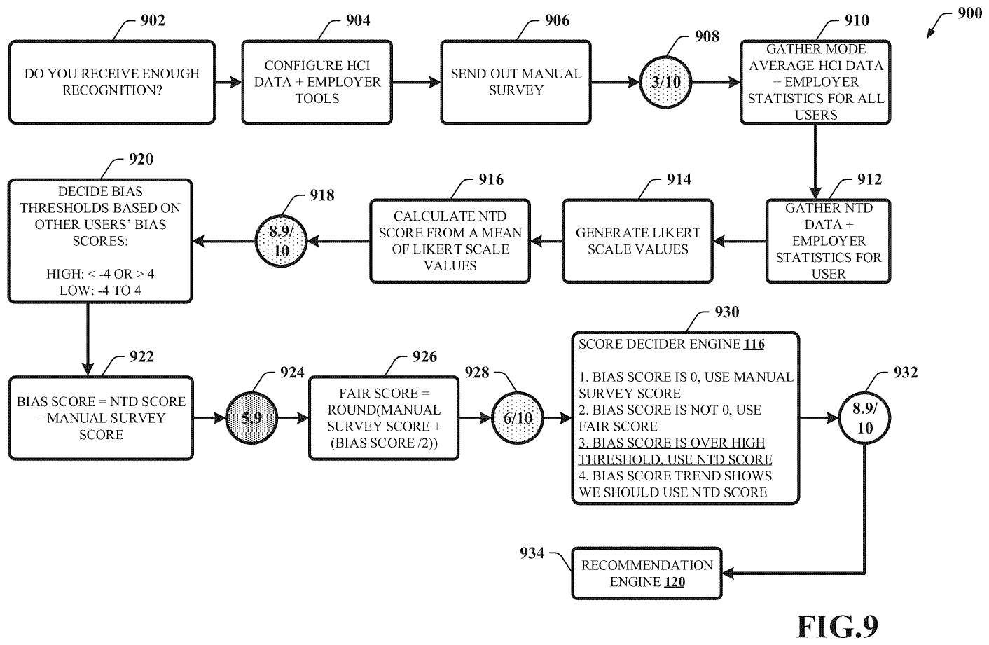

FIG. 9 illustrates a flow diagram of an example, non-limiting method 900 that can enable determination of a final score for an employment-based survey question based on an outlier in accordance with one or more embodiments described herein. Repetitive description of like elements and/or processes employed in respective embodiments is omitted for sake of brevity. One or more steps of non-limiting method 900 can be performed by one or more components of system 100.

In a non-limiting example, an employment-based survey generated by an employer or organization for individuals employed by the employer or organization can comprise one or more questions. For example, an employment-based survey question (e.g., question 902) can be “Do you receive enough recognition?” At 904, HCI data and employer-based data (employer tools) can be configured, wherein the HCI data and the employer-based data (collectively, digital data or NTD data) can comprise categories relevant to the question. For example, five categories of the digital data can be configured for question 902, as listed in table 3. A category of employer-based data can be “tracking percentage (%) of compensation increase,” whereas a category of HCI data can be “eye tracking on company comparison websites (e.g., Glassdoor, etc.)” (e.g., how many times did eyes fixate at phrases/words associated with recognition (e.g., pay rise, bonus, unhappy, negative reviews, etc.).

TABLE 3
Digital data categories for question 902

| | | | | Likert scale |
|---|---|---|---|---|
| | Categories | Mode-average | Digital data | values |
| 1 | Tracking number of | Positive: 2 (average) | Positive: 5 (better) | 10 |
| | positive/negative feedbacks | Negative: 2 (average) | Negative: 0 (better) | 10 |
| | in employer recognition | | | Median: 10 |
| | portal | | | |
| 2 | Tracking number of awards | 0 (average) | 1 (exceptional) | 10 |
| | received | | | |
| 3 | Tracking percentage (%) of | 2% (average) | 5% (better) | 8 |
| | compensation increase | | | |
| 4 | Tracking positive/negative | Positive: 1 (average) | Positive: 1 (same) | 5 |
| | feedback in emails | Negative: 0 (average) | Negative: 0 (exceptional) | 10 |
| | | | | Median: 7.5 |
| 5 | Eye tracking on company | Fixations: 40 (average) | Fixations: 23 (better) | 9 |
| | comparison websites (e.g., | | | |
| | Glassdoor, etc.) | | | |

At 906, a manual survey comprising question 902 can be sent to an individual within the organization and at 908, the individual can respond to question 902 with a manual survey score of 3/10. As stated elsewhere herein, the manual survey score can be generated against a Likert scale that can range from values 1-10. At 910, HCI data and employment-based (e.g., employer statistics) for all individuals can be collected for the categories listed in table 3 and a mode average value for each category can be generated as listed under the column heading “mode average” in table 3. The mode average value for a category of the digital data can be an amount seen the most across the organization for the category. At 912, digital data for the individual can be collected for the categories listed in table 3. The values for the digital data of the individual are listed under the column heading “digital data” in table 3.

At 914, Likert scale values for the digital data of the individual corresponding to question 902 can be generated by comparing the digital data values with the mode average values for respective categories. For example, for the category “tracking number of awards received,” a score of 0 can be considered average and a score of 1 can be considered exceptional, resulting in a Likert scale value of 10. For some categories, Likert scale value can be median values generated from two other Likert scale values. For example, for the category “tracking number of positive/negative feedbacks in employer recognition portal,” two Likert scale values can be generated-one for the number of positive feedbacks and one for the number of negative feedbacks. To generate a singular Likert scale value for the category, a median of the two Likert scale values can be computed to generate the final Likert scale value of 10. The various designations (e.g., average, worse, exceptional, etc.) for the mode average values and the digital data values can be as listed in table 3 alongside the corresponding Likert scale values. At 916, computation component 114 can calculate a mean value of the Likert scale values (e.g., median Likert scale values) to generate an NTD score for question 902 at 918. For example, the NTD score for question 902 can be 8.9/10 according to equation 3.

$$NTD score for question 902 = ( 10 + 10 + 8 + 7.5 + 9 ) / 5 = 8.9 \qquad Equation 3$$

At 920, bias thresholds can be decided for question 902 based on respective bias scores for individuals employed across the organization, wherein a bias score for an individual can be generated by subtracting a manual survey score from the NTD score. For example, bias thresholds for question 902 can comprise a high value of less than negative 4 (i.e., <−4) or greater than positive 4 (i.e., >4) and a low value between −4 and 4, wherein the bias thresholds can indicate that majority of the individuals can have bias scores between the ranges indicated herein. At 922, computation component 114 can subtract the manual survey score of the individual from the NTD score of the individual to generate a bias score for the individual at 924. For question 902, the bias score of the individual can be 5.9, which can indicate that the manual survey score provided by the individual has a high amount of bias. At 926, computation component 114 can divide the bias score by 2, add the value thus obtained to the manual survey score, and compute a nearest whole number of the resultant value (e.g., resulting from adding the manual survey score to half of the bias score) to generate a fair score at 928. For question 902, the fair score of the individual can be 6/10.

At 930, score decider engine 116 can use the bias score to determine a final score at 932. For example, the bias score being 5.9 for question 902 can indicate that the individual answered the question negatively, and yet, the high bias can indicate the individual being rewarded more that their peers. Thus, score decider engine 116 can select the NTD score as the final score due to the bias score being over a high value of a bias threshold, as indicated via the underlined at 930. Adjustment component 118 can adjust the manual survey score to the NTD score. At 934, recommendation engine 120 can use machine learning (e.g., an ML model) to suggest appropriate actions and interventions, based on the final score, that the employer of the individual can execute to maintain performance of the individual above a performance threshold. For example, recommendation engine 120 can recommend that the employer or a manager can have discussions with the individual to align thoughts and expectations better or to clarify to the individual that they are performing well, being rewarded more than other individuals, and are valued.

The machine learning can be trained over time to make the recommendations based on the final score. For example, a human entity can make initial recommendations based on the bias score and the final score to determine call-to-actions. For example, the human entity can analyze the bias score of 5.9 and recommend call-to-actions for the question. In one embodiment, a hardware, software, machine, AI, etc. can make the initial recommendations. Over time, such historical recommendations can be used to generate training data to train the machine learning to make the recommendations based on answers provided by the individual. For example, an administrator of a system can be presented with a UI. The UI can be presented in a spreadsheet-like format that can be displayed for each worker, each question and a respective score for the question. On a first run, call-to-action entries for each row can be empty. An administrator can enter call-to-actions so that upon encountering the same scores during a subsequent run, the machine learning can revisit the call-to-actions. The administrator can interact with a manager of the individual to generate the call-to-actions during the first run. In one embodiment, in addition to entering call-to-actions manually, the system can receive verbal inputs from the administrator or another individual. For example, the system can interface with a UI that can receive verbal information and process it to enter the call-to-actions. Further, a database can be loaded into a machine learning decision tree model, wherein the database can comprise multiple rows, and wherein each row can be a question. The database can further comprise a column for each score and a column for call-to-actions. Each time a row or column is updated, the database can act as training data for the machine learning decision tree model, and the database can be formed into an appropriate structure to load through the machine learning decision tree model.

In an embodiment, a large bias score (e.g., exceeding bias score thresholds) can indicate outliers, which can be accounted for by a score decider engine (e.g., score decider engine 116). However, when first creating call-to-actions for the ML, an entity creating the call-to-actions can write the call-to-actions according to the large bias. In one embodiment, the entity creating the call-to-actions can be a hardware, software, machine, AI or a human entity. For example, for the bias score of 5.9 that falls significantly outside the bias thresholds, even though a fair score can be computed, the fair score can not be considered truly fair (e.g., having reduced bias) due to the bias score being much further away from the manual survey score. Therefore, the bias score can indicate that an individual's thoughts can be very different than those of their employer for question 902. More specifically, the bias score can indicate that the manual survey score is an outlier, and the machine learning can be trained to use the NTD score as the final score since the NTD score can be derived from HCI data and employer-based data of the individual and be more reliable. For example, based on historical recommendations by a human entity to use the NTD score for situations where the bias score can be very high, the machine learning can be trained to use a specific batch of call-to actions. In one embodiment, a hardware, software, machine, AI, etc. can make the historical recommendations used for training the machine learning.

Further, different types of outliers can be analyzed for different questions. For example, a question can display a trend wherein the question can be a positive or negative type of question, and an entity can analyze the bias thresholds to determine outliers for the question. In one embodiment, the entity analyzing the bias thresholds can be a hardware, software, machine, AI, etc. Questions displaying specific trends (e.g., positive, negative, etc.) can be presented by a software to an entity (e.g., at a UI) and the entity can choose to remove the question from further analysis or use, for example, if the question is deemed too positive or too negative. In one embodiment, the entity choosing to remove the question can be a hardware, software, machine, AI, etc. A bias threshold trend observed over time for a question can indicate that the question is biased and the NTD score is to be used for the question each time. Further, there can be multiple recommendations for the question, for example, to change a manner of structuring the question, etc.

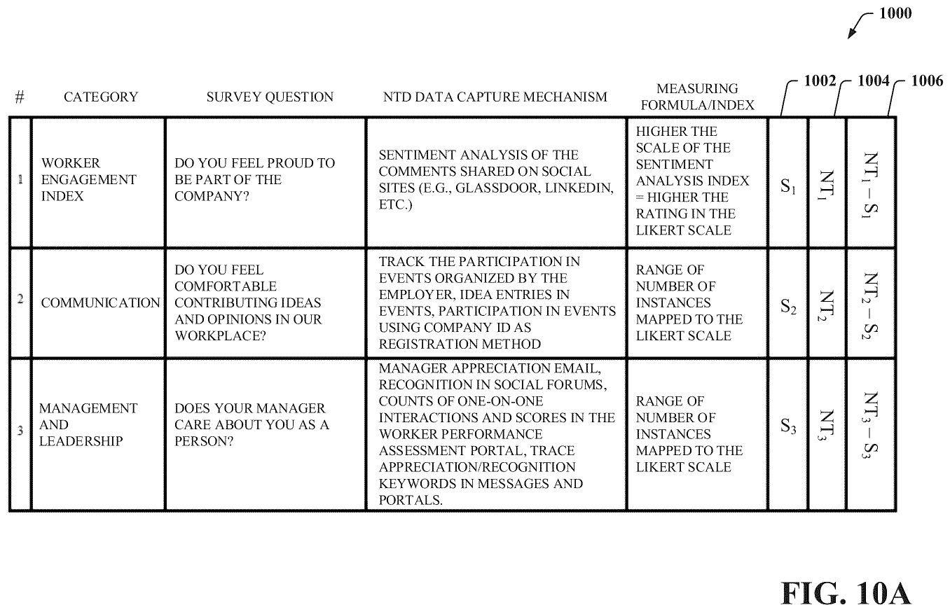

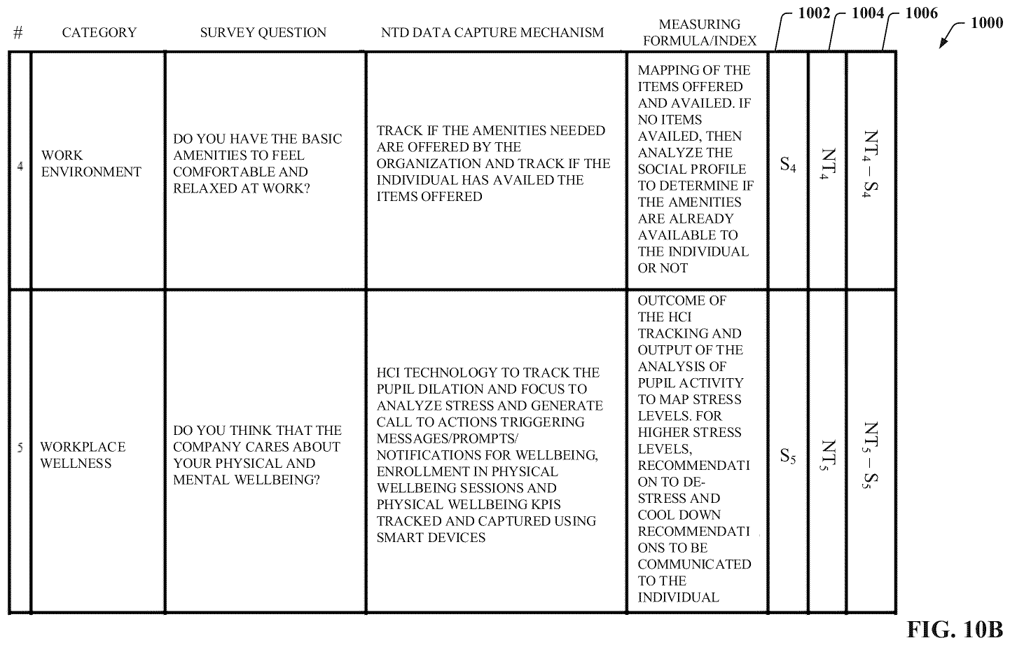

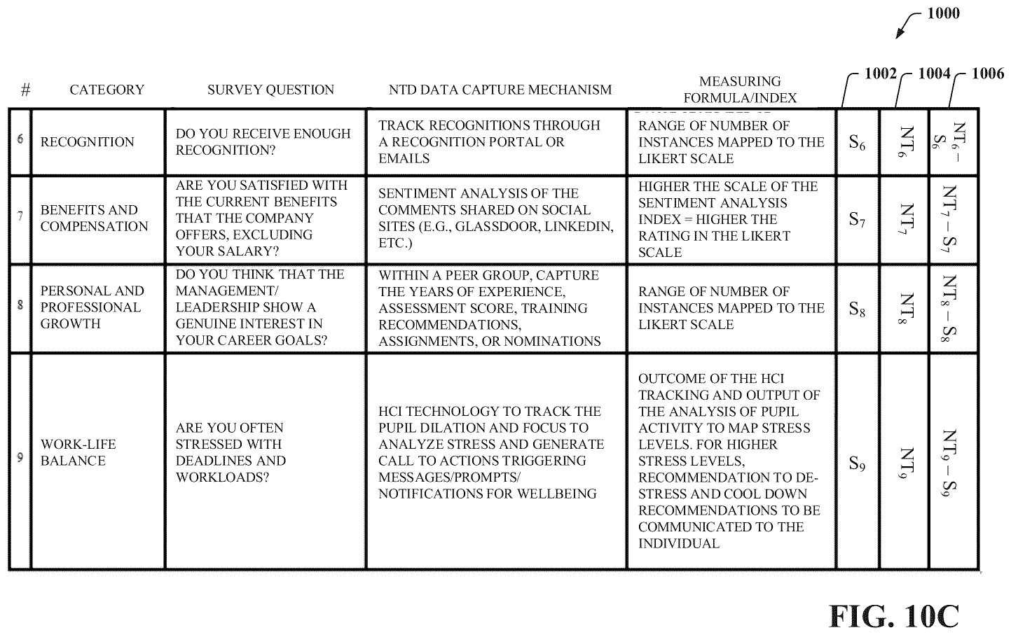

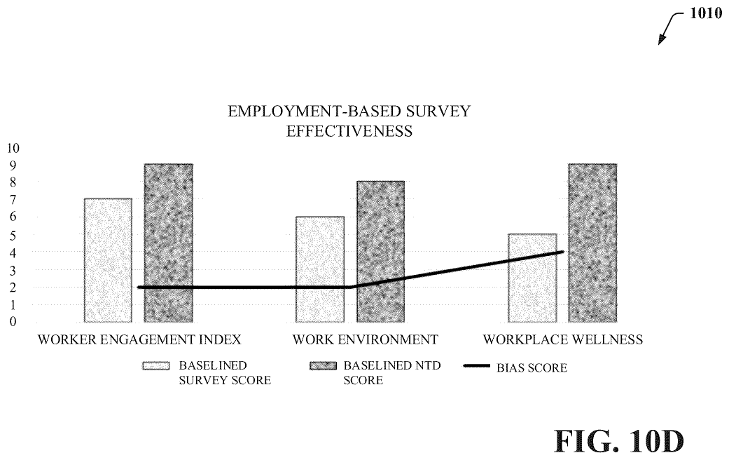

FIGS. 10A-10B illustrates a table 1000 based on an example, non-limiting employment-based survey in accordance with one or more embodiments described herein. Repetitive description of like elements and/or processes employed in respective embodiments is omitted for sake of brevity.

Table 1000 can illustrate questions 1-9 comprised in an employment-based survey, wherein questions 1-9 can belong to various categories (e.g., communication, work environment, work-life balance, etc.). Table 1000 can further illustrate NTD data capture mechanisms and corresponding measuring formulae/indexes used for implementing one or more embodiments herein. Column 1002, column 1004 and column 1006 can respectively list survey scores (e.g., S₁, S₂, . . . , S₉), NTD scores (e.g., NT₁, NT₂, . . . , NT₉) and effectiveness scores (e.g., NT₁-S₁, NT₂-S₂, . . . , etc.) for the respective questions. The employment-based survey can be generated for individuals employed in an organization, and various embodiments herein can enable a method of mapping collected HCI data to create scoring for surveys on a per question basis. For example, a survey score (e.g., Sₓ) for each question on the employment-based survey can be generated (e.g., by computation component 114 of FIG. 1) based on a mode average of the survey score found for the specific question of an enterprise survey. Further, an effectiveness of NTD data can be measured (e.g., by computation component 114) weekly by comparing the NTD score and the survey score (e.g., NTₓ-Sₓ), and the effectiveness can be categorized as “low,” “medium,” or “high.” If an effectiveness trend can be observed to be consistently positive or negative over time (e.g., a month, a quarter, etc.), then an NTD score can be considered as a final score (e.g., by score decider engine 116 of FIG. 1) to which the survey score can be adjusted. Based on the NTD score, call-to-actions can be deployed (e.g., implementing appropriate interventions based on stress levels observed for NTD score NT₉ of FIG. 10C).

To describe the concept more clearly, consider an analysis performed on a portion (e.g., questions 1, 4, 5 and 6) of the employment-based survey as listed in table 1000 and further in table 4. Question 1 (Q1) can be related to an worker engagement index, wherein Q1 can be “Do you feel proud to be part of the company?” Question 4 (Q4) can be related to a work environment, wherein Q4 can be “Do you have the basic amenities to feel comfortable and relaxed at work?”. Question 5 (Q5) can be related to workplace wellness, wherein Q5 can be “Do you think that the company cares about your physical and mental wellbeing?” Question 6 (Q6) can be related to recognition at the workplace, wherein Q6 can be “Do you receive enough recognition?” Additionally, survey scores (e.g., 1-10) can be generated for questions 1, 4, 5 and 6 based on a mode average of the survey score found for a specific question of an enterprise survey. For example, Q1 can have a survey score of 7, Q4 can have a survey score of 6, Q5 can have a survey score of 5 and Q6 can have a survey score of 3. The survey scores can be categorized as “medium,” “neutral,” or “low.” Based on the survey scores, respective baselined survey scores can be generated as listed in table 4.

TABLE 4
Net effective scores generated from survey scores

| | | | | Baselined | | Baselined | | |
|---|---|---|---|---|---|---|---|---|
| | | Survey | Survey | survey | NTD | NTD | Bias | Net |
| # | Category | Question | score | score | score | score | score | score |
| 1 | Worker | Q1 | 7 (medium) | 7 | 9 (high | 9 | 2 | 8 |
| | engagement | | | | positive) | | | |
| | index | | | | | | | |
| 4 | Work | Q4 | 6 (medium) | 6 | 8 (high) | 8 | 2 | 7 |
| | environment | | | | | | | |
| 5 | Workplace | Q5 | 5 (neutral) | 5 | 147 (high | 9 | 4 | 7 |
| | wellness | | | | fixation | | | |
| | | | | | count) | | | |
| 6 | Recognition | Q6 | 3 (low) | 3 | 9 (very | 9 | 6 | 6 |
| | | | | | high) | | | |

Further NTD data can be captured (e.g., by data collection component 108 of FIG. 1) for questions 1, 4, 5 and 6. An NTD data capture mechanism for Q1 (e.g., as also described in table 1000) can comprise sentiment analysis of comments shared on social sites (e.g., Glassdoor, LinkedIn, etc.). A data capture mechanism for Q4 (e.g., as also described in table 1000) can comprise tracking to determine whether amenities needed by an individual employed at the organization are offered by the organization and tracking to determine whether the individual has availed the items offered. A data capture mechanism for Q5 (e.g., as also described in table 1000) can comprise using HCI technology to track pupil dilation and focus to analyze stress and generate recommendations triggering messages/prompts/notifications for wellbeing of individuals. Enrollment in physical wellbeing sessions and physical wellbeing key performance indicators (KPIs) can be tracked and captured using smart devices. A data capture mechanism for Q6 (e.g., as also described in table 1000) can comprise tracking recognition awarded to individuals through recognition portals, emails, social channels, etc.

Based on the NTD data capture mechanism, a measuring formula/index can be determined for questions 1, 4, 5 and 6. For example, for Q1 and Q6, a higher scale of sentiment analysis index can be equal to a higher rating on a Likert scale (e.g., higher the scale of the sentiment analysis index=higher the rating in the Likert scale). For Q4, the measuring index can be based on mapping of items/amenities offered by the employer and availed by the individual. For a scenario wherein no amenities have been availed, a social profile of the individual can be considered to determine if the amenities are already available to the individual or not. For Q4, the measuring index can be based on an outcome of HCI tracking and an output of an analysis of pupil activity to map stress levels. Higher stress levels can correspond to recommendations to de-stress and cool down recommendations to be communicated to the individual.

Using the NTD data, Likert scale values can be generated (e.g., by computation component 114) for questions 1, 4, 5 and 6, as discussed in one or more embodiments herein, and the Likert scale value can be used to generate respective NTD scores for the questions. The NTD scores can be used to generate baselined NTD scores, for example, according to table 5. For example, for Q5, an NTD score of 147 can represent a high HCI fixation count, and based on table 5, an equivalent baselined NTD score can be 9. Effectiveness of the NTD data can be measured periodically (e.g., weekly) by comparing the NTD scores and the survey scores.

TABLE 5
NTD scores based on HCI fixation counts

| Rating | HCI Fixation Count | NTD Score |
|---|---|---|
| Very High | >=140 | 9-10 |
| High | 130-139 | 8 |
| Medium | 110-129 | 7-6 |
| Neutral | 100-109 | 5 |
| Low | 80-99 | 4-3 |
| Very Low | <=80 | 1-2 |

Further, bias scores can be generated (e.g., by computation component 114) for questions 1, 4, 5 and 6. For example, a difference of a baselined NTD score for a question and a baselined survey score for the question can be equal to a bias score for the question. The bias score can be categorized as “low” or “high,” for example, according to table 6. For a high bias score, a response (e.g., survey score) can be treated as an outlier and can not be considered for an overall evaluation scheme. Thereafter, fair scores or net effective scores (net scores in table 4) can be generated for the questions. For example, a net effective score for a question can be generated by halving a bias score for the question and adding the result to a corresponding survey score to arrive at a net effective score for the question.

TABLE 6
Bias score guidelines

| Rating | Bias Score |
|---|---|
| High | >4 |
| Low | 0-4 |

Bias scores for Q1, Q4, Q5 ad Q6 can be interpreted as follows. For Q1, a bias score of 2 can indicate presence of higher sentiments from an output of a sentiment analysis tool. Further, the low bias score can indicate that the survey score needs to be adjusted appropriately. For question Q4, a bias score of 2 can indicate that based on the social profiling, the profiling scores can reflect a comfortable work environment for the individual as established by the individual. Further, the low bias score can indicate that the survey score needs to be adjusted appropriately. For question Q5, a high average gaze can be detected, indicating a high stress level. A wellness break can be recommended. Further, a positive effectiveness score/net effective score can suggest that the survey score needs to be adjusted appropriately based on the effectiveness score. For question Q6, based on the sentiment analysis and the physical recognition records, it can be observed that the survey score can not reflect reality, whereas the NTD score can clearly show an actual status of recognition received by the individual, resulting in a very high bias score. Thus, a response by the individual should be treated as an outlier.

FIG. 10D illustrates an exemplary graph 1010 of effectiveness of an employment-based survey in accordance with one or more embodiments described herein. Repetitive description of like elements and/or processes employed in respective embodiments is omitted for sake of brevity.

Graph 1010 illustrates a comparison of baselined survey scores, baselined NTD scores and bias scores for questions 1, 4, and 5 of table 1000 for assessing effectiveness of the employment-based survey, in accordance with the description for FIGS. 10A-10B. The various scores for the question are identified by a legend in FIG. 10D.

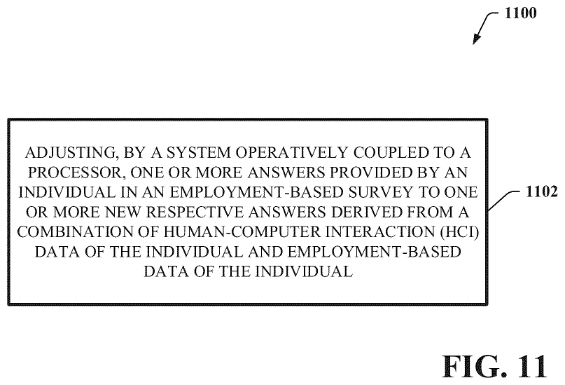

FIG. 11 illustrates a flow diagram of an example, non-limiting method 1100 that can employ a combination of HCI data of an individual and employment-based data of the individual to adjust an answer provided by the individual in an employment-based survey in accordance with one or more embodiments described herein.

At 1102, the non-limiting method 1100 can comprise adjusting (e.g., by adjustment component 118), by a system operatively coupled to a processor, one or more answers provided by an individual in an employment-based survey to one or more new respective answers derived from a combination of HCI data of the individual and employment-based data of the individual.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively collect HCI data of an individual or multiple individuals within an organization for adjusting an answer provided by the individual in an employment-based survey as the one or more embodiments described herein can enable this process. And, neither can the human mind nor a human with pen and paper combine the HCI data and the employment-based to refine employment-based engagement surveys, as conducted by one or more embodiments described herein.

FIG. 12 and the following discussion are intended to provide a brief, general description of a suitable computing environment 1200 in which one or more embodiments described herein at FIGS. 1-11 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as fair score generation code 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method can be distributed among multiple computers and/or between multiple locations. On the other hand, in this presentation of computing environment 1200, detailed discussion is focused on a single computer, specifically computer 1201, to keep the presentation as simple as possible. Computer 1201 can be located in a cloud, even though it is not shown in a cloud in FIG. 12. On the other hand, computer 1201 is not required to be in a cloud except to any extent as can be affirmatively indicated.

PROCESSOR SET 1210 includes one, or more, computer processors of any type now known or to be developed in the future. Processing circuitry 1220 can be distributed over multiple packages, for example, multiple, coordinated integrated circuit chips. Processing circuitry 1220 can implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set can be located “off chip.” In some computing environments, processor set 1210 can be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods can be stored in block 1245 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory can be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 can be a read only memory (ROM), but typically at least a portion of the persistent storage allows writing of data, deletion of data and re-writing of data. Some familiar forms of persistent storage include magnetic disks and solid-state storage devices. Operating system 1222 can take several forms, such as various known proprietary operating systems or open-source Portable Operating System Interface type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 can include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 can be persistent and/or volatile. In some embodiments, storage 1224 can take the form of a quantum computing storage device for storing data in the form of qubits. In embodiments where computer 1201 is required to have a large amount of storage (for example, where computer 1201 locally stores and manages a large database) then this storage can be provided by peripheral storage devices designed for storing large amounts of data, such as a storage area network (SAN) that is shared by multiple, geographically distributed computers. IoT sensor set 1225 is made up of sensors that can be used in Internet of Things applications. For example, one sensor can be a thermometer and another sensor can be a motion detector.

NETWORK MODULE 1215 is the collection of computer software, hardware, and firmware that allows computer 1201 to communicate with other computers through WAN 1202. Network module 1215 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201) and can take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 can be a client device, such as thin client, heavy client, mainframe computer and/or desktop computer.

REMOTE SERVER 1204 is any computer system that serves at least some data and/or functionality to computer 1201. Remote server 1204 can be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data can be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs can be stored as images and can be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware and firmware allowing public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed:

1. A system, comprising:
a memory that stores computer-executable components; and
a processor that executes the computer-executable components stored in the memory, wherein the computer-executable components comprise:
an adjustment component that adjusts one or more answers provided by an individual in an employment-based survey to one or more new respective answers derived from a combination of human-computer interaction (HCI) data of the individual and employment-based data of the individual.

2. The system of claim 1, further comprising:
a data collection component that collects the HCI data and the employment-based data of the individual, wherein the HCI data comprises digital device usage data of the individual, and wherein the employment-based data is sourced from an employer of the individual.

3. The system of claim 1, further comprising:
a tabulation component that tabulates the HCI data into respective analysis ratings defined by a worker engagement team associated with an employer of the individual to generate a categorization for the individual for adjusting the one or more answers.

4. The system of claim 1, further comprising:
a detection component that combines the HCI data and the employment-based data of the individual to detect human bias in the one or more answers provided by the individual.

5. The system of claim 1, wherein the combination of the HCI data and the employment-based data of the individual forms digital data, and wherein adjusting an answer of the one or more answers to a new answer comprises generating a first score based on a mean average value of individual scores derived from one or more values of the digital data.

6. The system of claim 5, wherein the first score is used to generate a second score that is representative of an amount of human bias in the answer, and wherein the second score is equal to a difference between the first score and a manual survey score representative of the answer.

7. The system of claim 5, wherein the individual scores are determined by mapping the one or more values of the digital data to a Likert scale.

8. The system of claim 6, further comprising:
a score decider engine that uses at least the second score to determine an amount of adjustment required for the answer, such that the human bias is reduced below a defined threshold.

9. The system of claim 8, further comprising:
a recommendation engine that uses machine learning to recommend one or more actions, based on the amount of adjustment, that an employer of the individual providing the answer can execute to maintain performance of the individual above a performance threshold.

10. The system of claim 9, wherein training data used to train the machine learning to recommend the one or more actions comprises information based on a human entity analyzing bias thresholds for the answer to determine outliers.

11. A computer-implemented method, comprising:
adjusting, by a system operatively coupled to a processor, one or more answers provided by an individual in an employment-based survey to one or more new respective answers derived from a combination of human-computer interaction (HCI) data of the individual and employment-based data of the individual.

12. The computer-implemented method of claim 11, further comprising:
collecting, by the system, the HCI data and the employment-based data of the individual, wherein the HCI data comprises digital device usage data of the individual, and wherein the employment-based data is sourced from an employer of the individual.

13. The computer-implemented method of claim 11, further comprising:
tabulating, by the system, the HCI data into respective analysis ratings defined by a worker engagement team associated with an employer of the individual to generate a categorization for the individual for adjusting the one or more answers.

14. The computer-implemented method of claim 11, further comprising:
combining, by the system, the HCI data and the employment-based data of the individual to detect human bias in the one or more answers provided by the individual.

15. The computer-implemented method of claim 11, wherein the combination of the HCI data and the employment-based data of the individual forms digital data, and wherein adjusting an answer of the one or more answers to a new answer comprises generating a first score based on a mean average value of individual scores derived from one or more values of the digital data.

16. The computer-implemented method of claim 15, wherein the first score is used to generate a second score that is representative of an amount of human bias in the answer, and wherein the second score is equal to a difference between the first score and a manual survey score representative of the answer.

17. The computer-implemented method of claim 15, wherein the individual scores are determined by mapping the one or more values of the digital data to a Likert scale.

18. The computer-implemented method of claim 16, further comprising:
determining, by the system, using the second score, an amount of adjustment required for the answer, such that the human bias is reduced below a defined threshold; and
recommending, by the system, using machine learning, one or more actions, based on the amount of adjustment, that an employer of the individual providing the answer can execute to maintain performance of the individual above a performance threshold.

19. A computer program product for minimizing human bias in answers provided by an individual in an employment-based questionnaire, the computer program product comprising a computer readable storage medium having program instructions embodied therewith, the program instructions executable by a processor to cause the processor to:
adjust, by the processor, one or more answers provided by an individual in an employment-based survey to one or more new respective answers derived from a combination of human-computer interaction (HCI) data of the individual and employment-based data of the individual.

20. The computer program product of claim 19, wherein the program instructions are further executable by the processor to cause the processor to:
collect, by the processor, the HCI data and the employment-based data of the individual, wherein the HCI data comprises digital device usage data of the individual, and wherein the employment-based data is sourced from an employer of the individual.
